(19) United States
(12) Patent Application Publication
(10) Pub. No.: US 2006/0015891 A1
(43) Pub. Date: Jan. 19, 2006

(54) Television audience reporting system and method

(76) Inventors: Michael J. Lazzaro, Chatham Township, NJ (US); Jonathan D. Gershan, Passaic, NJ (US); Ahmad R. Shishegar, Woodland Hills, CA (US)

Correspondence Address: ROBROY R FAWCETT, 1576 KATELLA WAY, ESCONDIDO, CA, 92027, US

(21) Appl. No.: 10/890,399

(22) Filed: Jul. 13, 2004

(51) Int. Cl. H04N 7/16; H04H 9/00; H04N 7/173

(52) U.S. Cl. 725/9; 725/14; 725/112; 725/110

(57) ABSTRACT

Disclosed is a television audience reporting system, and related method. The television audience reporting system includes a plurality of audience monitoring devices, a database server, and an internet server. The plurality of audience monitoring devices are located at a respective plurality of viewing locations for providing real-time program viewing information based on television channel selection by viewers at the respective viewing locations. The database server gathers the real-time program viewing information from the plurality of audience monitoring devices and generates a program viewing summary from the real-time program viewing information. The internet server provides the program viewing summary in real-time to client computers.

### BACKGROUND OF THE INVENTION

1. Field of the Invention

The present invention relates to a television audience reporting system, and more particularly, to a system for providing a summary of real-time audience viewing information to client computers.

2. Description of the Prior Art and Related Information

Television audience information is used to rank programs and to set rates for advertising commercials. Current rating services have been criticized with respect to accuracy and effectiveness. Also, current rating services generally provide audience information in a format this is only useful in future programming and advertising rate decisions.

Accordingly, there exists a need for a system that may provide audience viewing information in a more effective and timely manner. The present invention satisfies these needs.

### SUMMARY OF THE INVENTION

The present invention may be embodied in a television audience reporting system and related method. The television audience reporting system includes a plurality of audience monitoring devices, a database server, and an internet server. The plurality of audience monitoring devices are located at a respective plurality of viewing locations for providing real-time program viewing information based on television channel selection by viewers at the respective viewing locations. The database server gathers the real-time program viewing information from the plurality of audience monitoring devices and generates a program viewing summary from the real-time program viewing information. The internet server provides the program viewing summary in real-time to client computers.

In more detailed features of the invention, the data base server may correlate the real-time program viewing information with viewer characteristics to generate real-time audience profile information. The internet server may provide, in real-time, the real-time audience profile information only to client computers of profile information subscribers. The internet server may be a web server or a streaming media server.

### BRIEF DESCRIPTION OF THE DRAWINGS

The accompanying drawings illustrate embodiments of the present invention and, together with the description, serve to explain the principles of the invention.

FIG. 1 is a block diagram of a television audience reporting system for providing a real-time program viewing summary, according to the present invention.

FIG. 2 is a flow chart illustrating a method for providing a television audience viewing summary in real-time, according to the present invention.

FIG. 3 is an exemplary program viewing summary, according to the present invention.

FIG. 4 is an exemplary detailed program viewing summary, according to the present invention.

FIG. 5 shows popup menus for customizing a program viewing summary.

FIG. 6 is an exemplary custom viewer segment selection screen.

### DETAILED DESCRIPTION

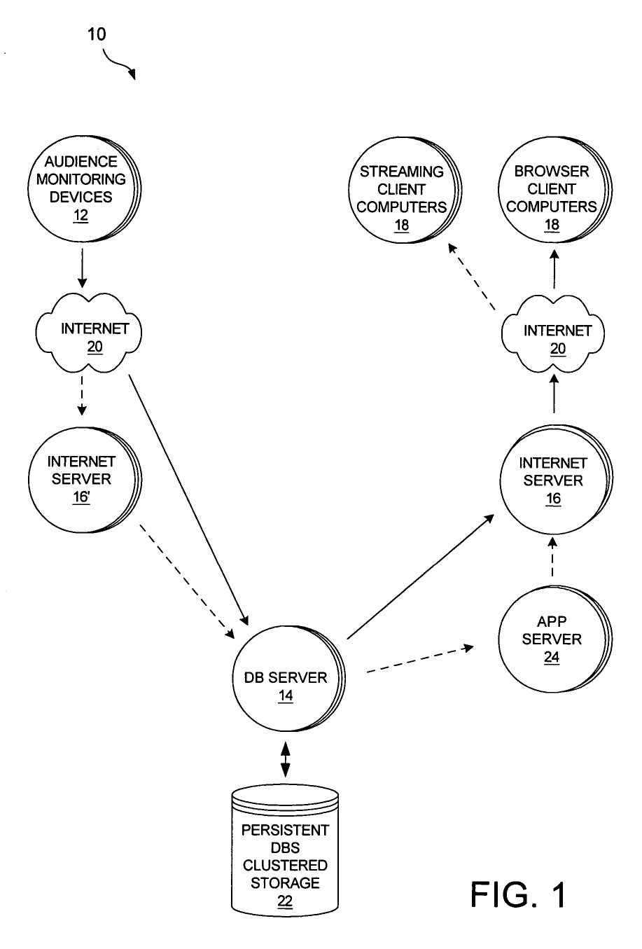

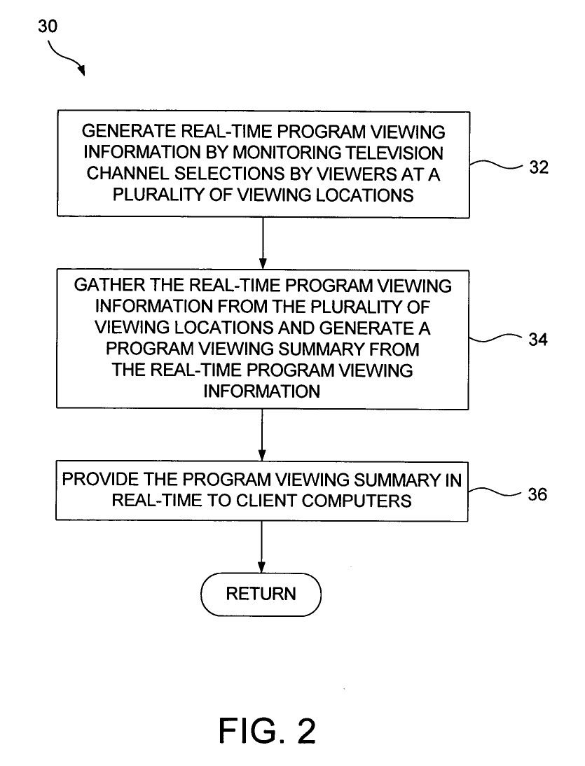

With reference to FIGS. 1 and 2, the present invention may be embodied in a television audience reporting system 10 and related method 30. The television audience reporting system 10 includes a plurality of audience monitoring devices 12, a database server 14, and an internet server 16. The plurality of audience monitoring devices 12 are located at a respective plurality of viewing locations for providing real-time program viewing information based on television channel selection by viewers at the respective viewing locations (step 32). The database server 14 gathers the real-time program viewing information from the plurality of audience monitoring devices 14 and generates a program viewing summary from the real-time program viewing information (step 34). The internet server 16 provides the program viewing summary in real-time to client computers 18 (step 36).

Further, the data base server 14 may correlate the real-time program viewing information with viewer characteristics to generate real-time audience profile information. The database server 14 has access to television program information such as program name, type (drama, suspense, comedy, etc.), episode name and number, program length, and syndication status. The viewer characteristics may relate to demographics such as age, gender, income, marital status profession, hobbies, affiliations, and the like. The viewer characteristics may also relate to household information such as household net worth, presence of children, region, state, market, or psycho-demographic cluster. The real-time program viewing summary may be useful to program providers and to viewers. For example, a viewer in a particular demographic category may be interested in determining which television programs currently being delivered have a high audience rating in the viewer's demographic category. The viewer may access the real-time program viewing summary using the internet 20 and then select a television program of interest based on the audience rating for the particular demographic category. Similarly, a television program provider may set advertising rates in real-time based on the audience rating. In a program in which contestants compete for prizes, the television program provider may award a prize having a value based on the program viewing summary. A higher value prize may be awarded during a television program having a higher viewing audience.

The monitoring devices 12 may implement any of a variety of techniques for obtaining the real-time programming viewing information. Advantageously, the monitoring device may be a set-top box located between a viewer's television set and the incoming signal from a television antenna or cable system. The set-top box transmits the program viewing information in real-time over the internet 20 or other suitable communication facility to the database server 14. The program viewing information may include the television channel viewed, channel changes, time stamp, etc. for each television in a household, and may be updated about every second or faster, depending on network conditions. The database server may store a copy of the real-time program viewing information in persistent storage 22, such as a database cluster having hard-disk drives. The viewer characteristics also may be stored in the persistent storage. The database server also has access to television program provider information such as station name, code, call letters, type (cable, direct-broadcast satellite, analog or digital broadcast, etc.) network affiliation, market, cost (basic/premium), or subscribers.

The internet server 16 may provide detailed real-time audience profile information only to client computers 18 of profile information subscribers. Advantageously, a television program provider may become a subscriber allowing it to obtain a real-time program viewing summary having detailed audience profile information that is not available to a non-subscriber. A non-subscriber may still access a less detailed program viewing summary available for free over the internet 20.

Additional functionality may be performed using an application server 24 situated between the database server 14 and the outgoing internet server 16 and/or an incoming internet server 16′ situated between the internet 20 and the database server 14. Each internet server may be a web server and/or a streaming media server, as appropriate. A “server” may be virtual and the described servers may denote parallel logical processes running on the same physical processor, box, or blade frame. Also, based on system load levels, each server may be implemented by several physical processors operating simultaneously and/or in parallel, and additional physical data paths may be constructed between the audience monitoring devices 12, the client computers 18, and the database servers 14.

The client computers 18 may present the program viewing summary using a streaming data client or using a web browser. The client computers 18 may communicate with the internet server 16 in real-time using the http and/or TCP/IP protocols, or future methods. The internet server 16 may “push” the summary to the client computers, or may provide the summary based on a browser request. The additional data paths may be dedicated only to streaming data or only to browser data.

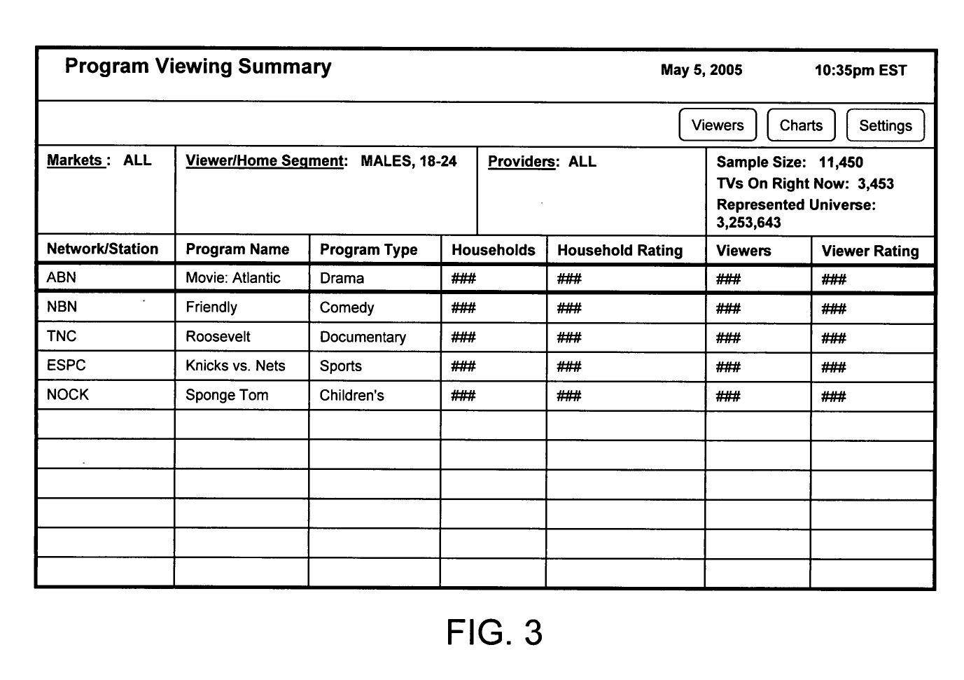

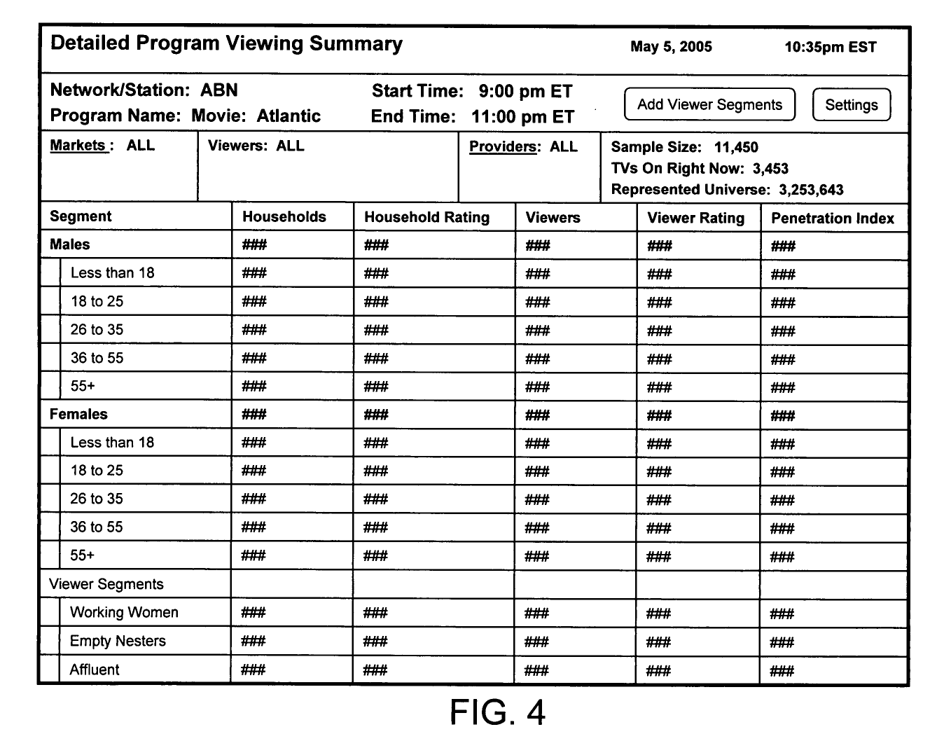

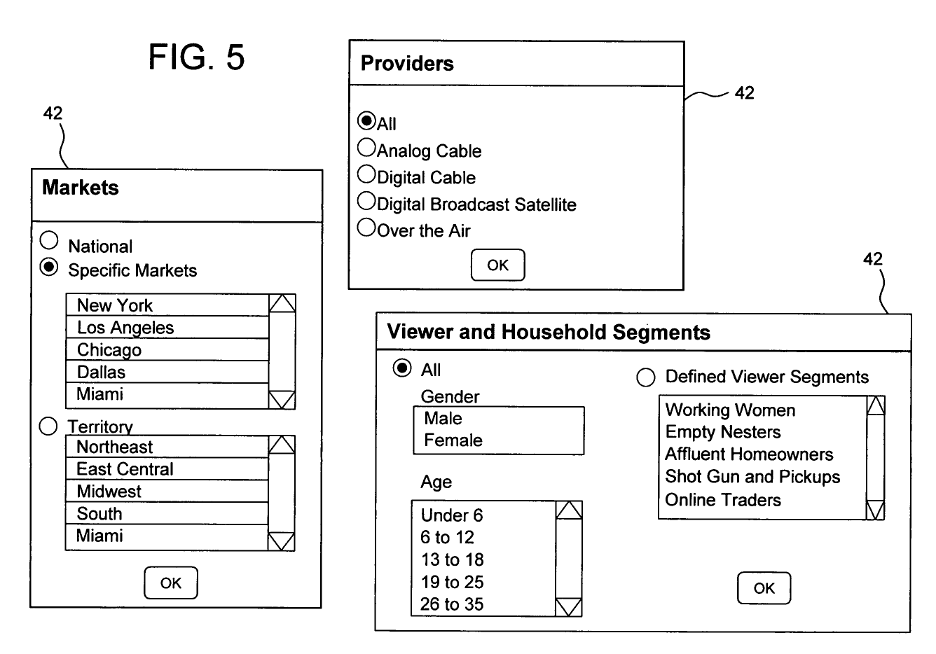

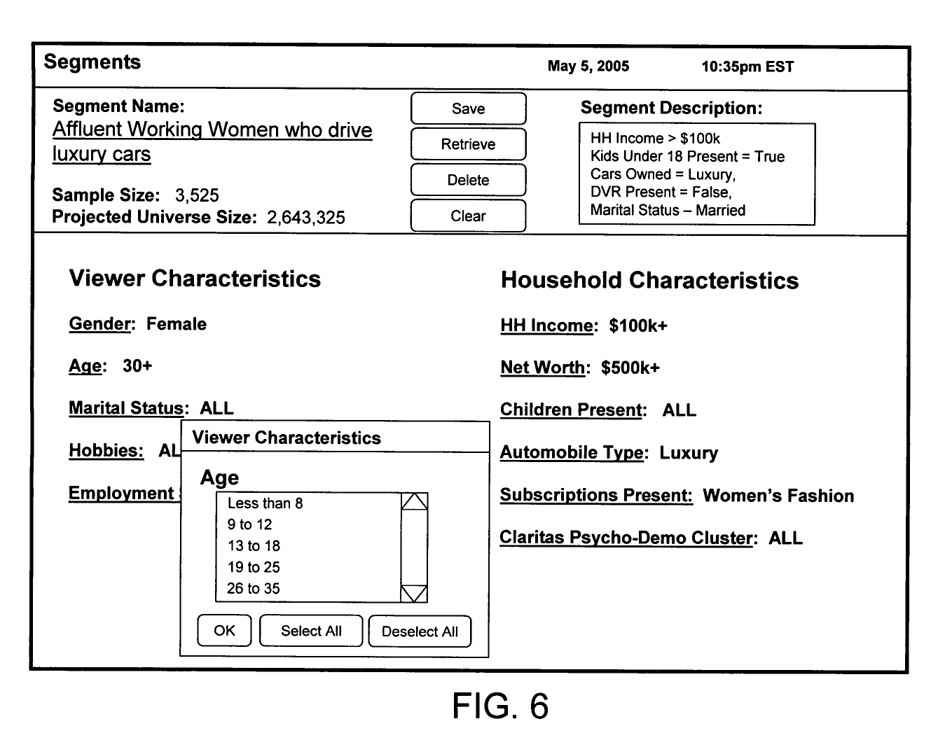

An exemplary program viewing summary is shown in FIG. 3. The summary may list the network/station, program name, program type, households, household rating, viewers, and viewer rating. The summary may also provide the number of viewers, televisions tuned to a program, households watching a program, etc. An exemplary detailed program viewing summary shown in FIG. 4. The detailed program viewing summary has the real-time viewing information broken down based on particular demographic characteristics. A program viewing summary may be further customized by market, program provider, viewer and household segments, etc., using popup menus 42 shown in FIG. 5. An exemplary custom viewer segment selection screen is shown in FIG. 6. The custom viewer segment may be used to generate custom detailed reports and analysis that may be available only to a subscriber.

The real-time program viewing summary allows for more timely and effective programming and advertising rate decisions. The program summary is generated as fast as possible in real-time subject to communication and processing latency. Depending on the data complexity, a real-time program viewing summary may be generated within one or two seconds of gathering of the real-time program viewing information from the audience monitoring devices. Based on network load conditions, the browser may update the program viewing summary as often as every second, or less frequently, such as about every ten seconds. “Push” technology may allow the internet server 16 to control the summary update rate. After about a minute, the data in a program viewing summary may become stale, and may lose its real-time value.

What is claimed is:

1. A television audience reporting system, comprising:
a plurality of audience monitoring devices located at a respective plurality of viewing locations for providing real-time program viewing information based on television channel selection by viewers at the respective viewing locations;
a database server for gathering the real-time program viewing information from the plurality of audience monitoring devices and generating a program viewing summary from the real-time program viewing information; and
an internet server for providing, in real-time, the program viewing summary to client computers.

2. A television audience reporting system as defined in claim 1, wherein data base server is further for correlating the real-time program viewing information with viewer characteristics to generate real-time audience profile information, and the internet server is for further providing, in real-time, the real-time audience profile information only to client computers of profile information subscribers.

3. A television audience reporting system as defined in claim 1, wherein the internet server comprises a web server.

4. A television audience reporting system as defined in claim 1, wherein the internet server comprises a streaming media server.

5. A method for television audience reporting, comprising:
generating real-time program viewing information by monitoring television channel selections by viewers at a plurality of viewing locations;
gathering the real-time program viewing information from the plurality of viewing locations and generating a program viewing summary from the real-time program viewing information; and
providing, in real-time, the program viewing summary to client computers requesting the summary.

6. A method for television audience reporting as defined in claim 5, further comprising:
correlating the real-time program viewing information with viewer characteristics to generate real-time audience profile information; and
providing, in real-time, the real-time audience profile information only to client computers of profile information subscribers.
